(19) United States
(12) Patent Application Publication
(10) Pub. No.: US 2004/0267630 A1
(43) Pub. Date: Dec. 30, 2004

(54) Supplier hub with hosted supplier stores

(75) Inventors: Michael K. Au, Markham (CA); Conan Ming Y. Chan, Markham (CA); Sau Chu Chan, Thornhill (CA); Lev Mirlas, Thornhill (CA); Alex Shum, Thornhill (CA)

Correspondence Address: John D. Flynn, IBM Corporation, Dept. T81/Bldg. 503, PO Box 12195, Research Triangle Park, NC, 27709, US

(73) Assignee: International Business Machines Corporation, Armonk, NY

(21) Appl. No.: 10/751,742

(22) Filed: Jan. 5, 2004

(30) Foreign Application Priority Data
Jun. 26, 2003 (CA) 2,433,471

(51) Int. Cl. G06F 17/60

(52) U.S. Cl. 705/26

(57) ABSTRACT

An online marketplace for commerce between multiple buyers and multiple suppliers. The marketplace includes hosted supplier stores opened, managed and maintained by individual registered suppliers. The suppliers upload supplier catalog information to the hosted supplier stores. The marketplace also includes a supplier hub, or general open market, where registered buyers can browse an aggregated catalog made up from an aggregation of the supplier catalogs from the hosted supplier stores. The marketplace administrator may define a catalog topology based upon which the suppliers may structure their own supplier catalogs, thereby easing aggregation of the supplier catalogs into the aggregated catalog. The marketplace also includes trading mechanisms for conducting online ordering, purchasing, requests for quotations, and negotiations. The marketplace also recognizes and enforces contracts between the buyers and the suppliers, whereby a supplier has granted a buyer certain entitlements, in terms of access or pricing, to a buyer in relation to a particular product. The marketplace ensures that the terms and conditions of the contract are enforced in the course of catalog browsing, pricing, and ordering.

### CROSS REFERENCE TO RELATED APPLICATIONS

This application claims priority under 35 U.S.C. § 119 based upon an application filed in Canada (CA) on Jun. 26, 2003 having a Canadian application number 2,433,471 entitled SUPPLIER HUB WITH HOSTED SUPPLIER STORES, which is incorporated herein by reference.

### TECHNICAL FIELD

This invention relates to a system and method for providing a marketplace with a supplier hub having a plurality of hosted supplier stores.

### BACKGROUND INFORMATION

Large enterprise buyers face a challenge in managing multiple supplier relationships and improving efficiency in their procurement processes. One avenue to improving the efficiency of procurement is to provide for more direct competition between suppliers and thereby improve costs for the buyer. If more direct competition can be fostered between suppliers, then the transaction costs to the buyer in choosing among suppliers are reduced, improving the overall cost of the goods or services obtained.

Although such a market is attractive to buyers, suppliers resist participating in more directly competitive marketplaces because more direct competition reduces their margins. Moreover, to the extent that the directly competitive marketplace requires a technological investment by the supplier in order to participate, the supplier's costs are increased. In addition to the direct costs of participating, the supplier may lack the requisite technical knowledge to participate effectively. The cost, in terms of time and money, of acquiring the necessary technical knowledge can be a barrier to entry for some suppliers.

Similarly, there are cost and technological barriers to entry for suppliers that want to provide customers with a direct sales outlet. A direct sales outlet is an attractive vehicle for suppliers who want to participate in broader marketplaces. In the past, suppliers faced with the cost and technology challenges of opening a direct sales outlet have often outsourced that activity to a third party, especially in the context of an e-commerce outlet. This approach addresses the concern with a lack of technical knowledge, but leaves cost problems and has the drawback that some measure of control is lost to the third party.

Accordingly, a need still exists for a system or method that provides a marketplace that addresses some of the aforementioned challenges.

### SUMMARY OF THE INVENTION

The present invention provides an online marketplace for multiple buyers and multiple suppliers, through which suppliers can open and manage their own hosted supplier store using a set of store management tools, including the uploading and maintenance of their own supplier catalog. The marketplace provides buyers with the option of shopping through individual hosted supplier stores or through a central supplier hub that provides the buyer with an aggregated catalog made up from an aggregation of the supplier catalogs. The aggregation of supplier catalogs into the aggregated catalog may be performed in a variety of ways, including organizing supplier catalog data according to a predetermined taxonomy specified by a marketplace administrator or organizing data according to a simple catalog structure with no taxonomy. In one embodiment, the present invention provides transaction mechanisms, including a request-for-quotation process allowing buyers to solicit selected suppliers for a quote on a made-to-order item, and the negotiation and ordering mechanisms to finalize the transaction.

In one aspect, the present invention provides-a method of creating a marketplace with hosted supplier stores. The method includes the steps of providing tools for creating and managing a hosted supplier store to each of a plurality of suppliers through a commerce site, the tools including a catalog facility for uploading and managing a supplier catalog for the hosted supplier store, receiving a plurality of supplier catalogs from the plurality of suppliers, aggregating the plurality of supplier catalogs into an aggregated catalog, and providing a buyer with access to the aggregated catalog on the commerce site.

In another aspect, the present invention provides a computer program product having a computer-readable medium tangibly embodying computer executable instructions for creating a marketplace with hosted supplier stores. The computer executable instructions include computer executable instructions for creating and managing a hosted supplier store through a commerce site, the tools including a catalog facility for uploading and managing a supplier catalog for the hosted supplier store, computer executable instructions for receiving a plurality of supplier catalogs from the plurality of suppliers, computer executable instructions for aggregating the plurality of supplier catalogs into an aggregated catalog, and computer executable instructions for providing a buyer with access to the aggregated catalog on the commerce site.

In yet another aspect, the present invention provides a system for online commerce between multiple buyers and multiple suppliers. The system includes a member subsystem for registering buyers and suppliers, whereby registered buyers are permitted to access the system for online commerce, and registered suppliers are permitted to access the system to create and manage a hosted supplier store, a database having stored thereon a plurality of supplier catalogs uploaded by registered suppliers for a plurality of hosted supplier stores, a catalog subsystem for aggregating the plurality of supplier catalogs into an aggregated catalog, and an application server for providing the registered buyers with access to the aggregated catalog on the commerce site.

In yet a further aspect, the present invention provides an online marketplace for commerce between multiple buyers and multiple suppliers. The online marketplace includes a plurality of hosted supplier stores opened, managed and maintained by respective registered suppliers, the hosted supplier stores each including a supplier catalog of categories, products, and items uploaded by the respective registered supplier, an aggregated catalog of categories, products, and items that includes an aggregation of the supplier catalogs, trading mechanisms, including item ordering, requests for quotations, and contract negotiation, and a supplier hub through which a registered buyer browses the aggregated catalog and utilizes the trading mechanisms.

Other aspects and features of the present invention will be apparent to those of ordinary skill in the art from a review of the following detailed description when considered in conjunction with the drawings.

### BRIEF DESCRIPTION OF THE DRAWINGS

Reference will now be made, by way of example, to the accompanying drawings which show an embodiment of the present invention, and in which:

FIG. 1 shows, in diagrammatic form, a model of an on-line marketplace having a supplier hub and hosted supplier stores;

FIG. 2 shows, in block diagram format, an embodiment of a system topology for providing a supplier hub having hosted supplier stores, according to the present invention;

FIG. 3 shows, in block diagram form, a system for providing a supplier hub having hosted supplier stores, according to the present invention;

FIG. 4 diagrammatically shows a model of the relationships between stores for the purpose of creating an aggregated catalog;

FIG. 5 shows a tree-and-branch diagram of an aggregated catalog, according to the present invention;

FIG. 6 shows, in flowchart form, a method for hosting suppliers and providing a supplier hub in an on-line marketplace, according to the present invention;

FIG. 7 shows, in flowchart form, a method of determining pricing entitlement, according to the present invention; and

FIG. 8 shows, in flowchart form, a method of determining access entitlement, according to the present invention.

Similar references are used in different figures to denote similar components or features.

### DETAILED DESCRIPTION

The following detailed description of the present invention does not limit the implementation of the invention to any particular computer programming language. The present invention may be implemented in any computer programming language provided that the operating system provides the facilities to support the requirements of the present invention. In one embodiment, the present invention is implemented, at least partly, in the Java computer programming language. Any limitations presented herein as a result of a particular type of operating system or computer programming language are not intended as limitations of the present invention.

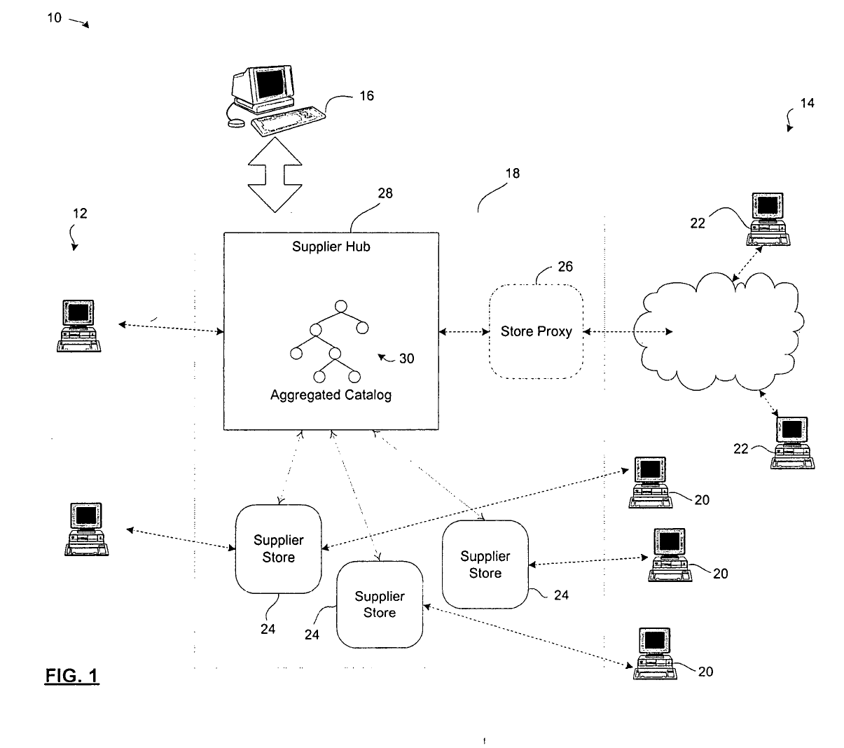

Reference is first made to FIG. 1, which shows, in diagrammatic form, a model 10 of an online marketplace 18 having hosted and remote suppliers, in accordance with the present invention.

The model 10 includes three categories of participants: buyers 12, suppliers 14, and an administrator 16. In some embodiments, the administrator 16 will also be a buyer 12. The administrator 16 is responsible for deploying and managing the online marketplace 18.

The online marketplace 18 includes a supplier hub 28 in which the buyers 12 can browse an aggregated catalog 30 aggregated from the individual catalogs of each of the suppliers 14.

The suppliers 14 may be hosted suppliers 20 or remote suppliers 22. A hosted supplier 20 is a supplier 14 that has chosen to open a hosted store front 24 within the online marketplace 18. The hosted store front 24 is a supplier-specific direct sales outlet that allows the hosted supplier 20 to trade directly with individual buyers 12 and allows the hosted supplier 20 to manage and customize their store outlet in accordance with their specific branding and marketing strategies. The hosted suppliers 20 upload their supplier catalog to their hosted store front 24 using self-provisioning store management tools provided through the online marketplace 18.

Remote suppliers 22 are suppliers 14 that have not chosen to open a store outlet within the online marketplace 18, but have nevertheless registered with the online marketplace 18 to participate in the supplier hub 28 and have uploaded their product offerings and pricing. A store proxy 26 within the commerce site 18 serves to communicate transactional information between buyers 12 in the supplier hub 28 and the remote system of a particular remote supplier 22.

The online marketplace 18 includes a number of flexible trading mechanisms for creating orders between buyers 12 and suppliers 14. For example, the online marketplace 18 provides suppliers 14 with the capability of establishing auctions of particular products, establishing fixed prices for products, and establishing contract prices for products based upon contract relationships with particular buyers. Buyers 12 may utilize a request for quotation (RFQ) mechanism to solicit quotations for particular products, especially custom products specific to the buyer's needs. Further details regarding these trading mechanisms are given below. The online marketplace 18 may provide other negotiation, pricing, or trading mechanisms.

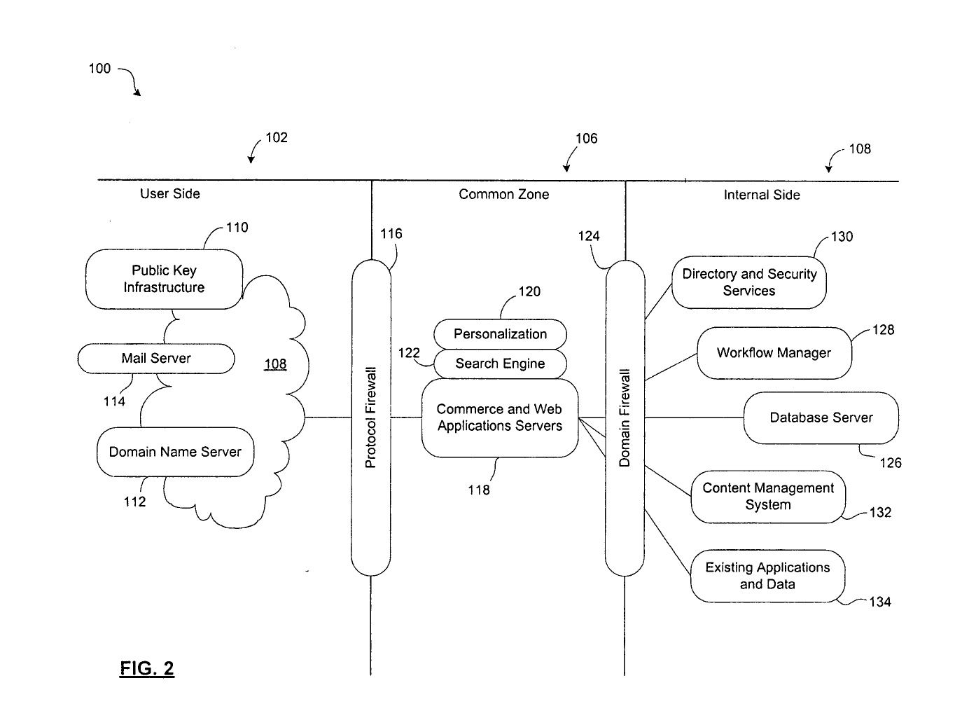

Reference is now made to FIG. 2, which shows, in block diagram format, an embodiment of a system topology 100 for implementing the online marketplace 18 (FIG. 1) having the supplier hub 28 (FIG. 1) and hosted supplier stores 24 (FIG. 1), according to the present invention. The system topology 100 includes a user side 102 and an internal side 104, with a common zone 106 in between. The user side 102 of the system 100 includes the computer network, like the Internet 108, that the buyers and suppliers use to access the system. Included in the user side 102 of the system are a public key infrastructure 110, a domain name server 112, and a mail server 114.

The user side 102 is separated from the common zone 106 by a protocol firewall 116. The common zone 106 includes the commerce and web application servers 118. The commerce and web application servers 118 implement the web server and application logic of the commerce front end. They provide the commerce application and associated transactional services. They also facilitate connections with database server nodes and back-end order processing systems.

Also included in the common zone 106 are personalization functions 120 and a search engine 122. The personalization functions 120 define the roles of individuals and organizations within the online marketplace and, therefore, the data available to individuals and organizations and the operations they can perform. For example, the identity of a buyer, i. e., whether they have specific contracts with suppliers, may affect the view and the price of products that they are entitled to receive. In other words, under an entitlement-based system the view of and the price of the catalog items is customized to the entitlement of the specific user based upon a contract between the user and the supplier.

The search engine 122 services user requests to search or browse the catalog of items.

The common zone 106 is separated from the internal side 104 by a domain firewall 124. Within the internal side 104 are a database server 126, a workflow manager 128, directory and security services 130, a content management system 132, and existing applications and data 134.

The database server 126 is a data repository for transactions occurring within the system. For example, the database server 126 may store the order and delivery information for a transaction between a buyer and a supplier. It may also store banking, credit or other financial information in relation to specific buyers or suppliers.

The workflow manager 128 routes operations for users and applications within the system. For example, the workflow manager 128 determines the approver for an order or registration according to an approval group in the organizational hierarchy for the user who submits the order or the registration form.

The content management system 132 provides the functions of creating catalog data for the database server 126 and commerce and web application server 118 nodes. The catalog data includes the items available for sale from the suppliers and their associated details, including pricing information. The content management system 132 handles the submission of catalog data from multiple suppliers and manages the integration of that data into an aggregated catalog.

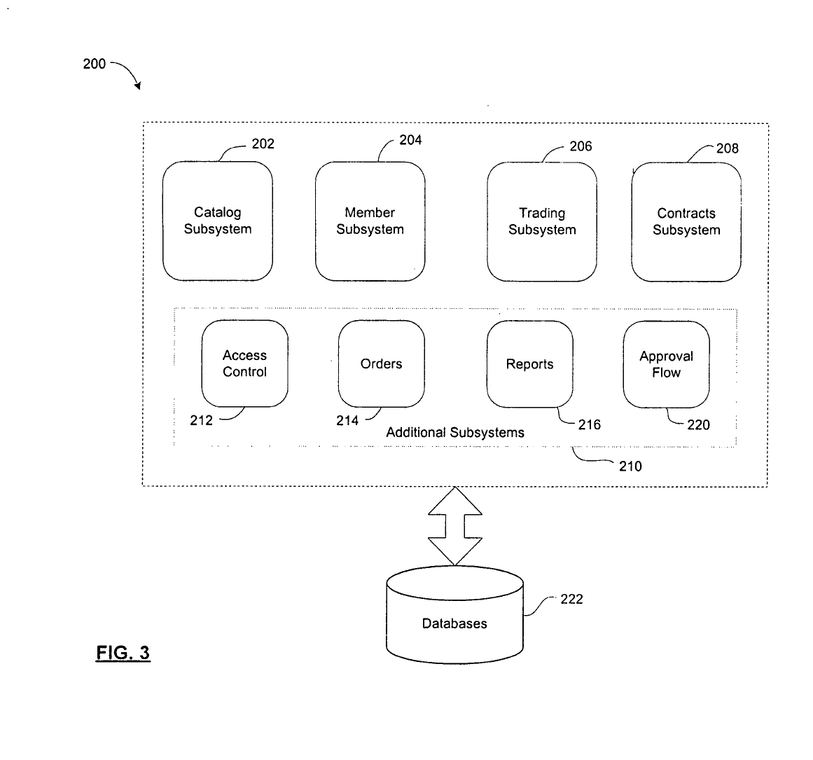

Reference is now made to FIG. 3, which shows, in block diagram form, a system 200 for providing a supplier hub 28 (FIG. 1) with hosted supplier stores 24 (FIG. 1), according to the present invention. The system 200 includes a number of subsystems, including a catalog subsystem 202, a member subsystem 204, a trading subsystem 206, and a contracts subsystem 208. Additional subsystems 210 include an access control subsystem 212, an orders subsystem 214, a reports subsystem 216, and an approval flow subsystem 220. The system 200 further includes one or more databases 222.

The catalog subsystem 202 includes a catalog topology established by the system administrator. The catalog subsystem 202 receives catalog data from a registered supplier in one of many possible formats, including spreadsheet, browser, XML, or others. Each supplier may upload their specific catalog data to the system 200 and it will be integrated within the aggregated catalog 30 (FIG. 1). A buyer browsing the supplier hub 28 (FIG. 1) is able to view an aggregated catalog containing all of the supplier hub or supplier-specific categories, products and items. A buyer browsing within a specific hosted supplier store front 24 (FIG. 1) is able to view an aggregated catalog containing all the supplier hub categories, products and items and all the categories, products and items specific to the supplier associated with that hosted store front 24.

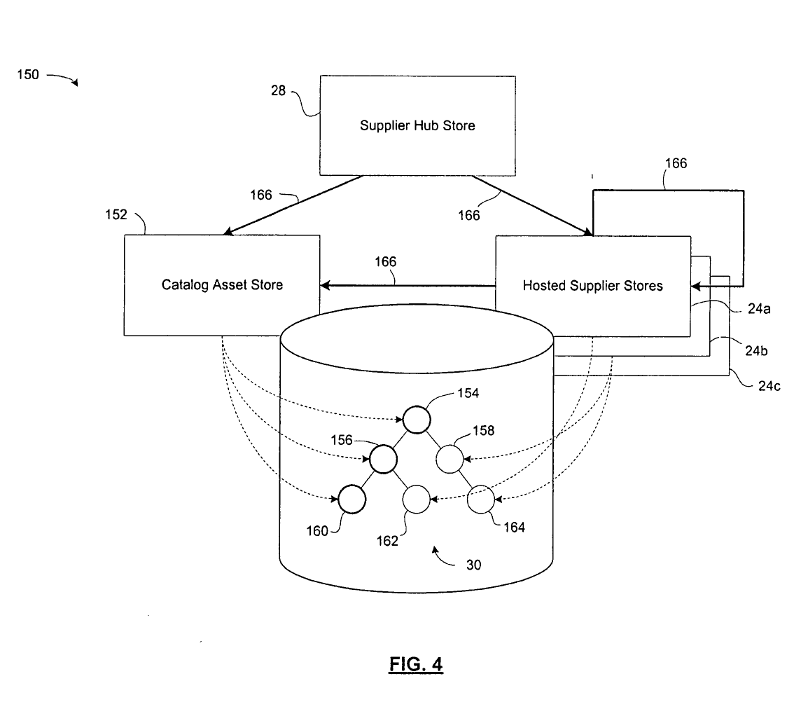

Reference is now made to FIG. 4, which diagrammatically shows a model 150 of the relationships between stores for the purpose of creating the aggregated catalog 30. The model 150 includes the supplier hosted store fronts 24, shown individually as 24a, 24b, and 24c. The model 150 also includes the supplier hub store 28 and a catalog asset store 152.

The catalog asset store 152 is not a store, per se, in the sense that a buyer could shop within it, but it is built upon the model of a store and is maintained by the hub administrator 16 (FIG. 1). The catalog asset store 152 contains a catalog of categories and products defined by the administrator 16. These are “shared” or “marketplace” categories of products that any supplier may offer. Through the catalog asset store 152, the administrator 16 establishes a catalog topology for the online marketplace 18 (FIG. 1). In the model 150 shown in FIG. 4, the catalog asset store 152 specifies categories/products 154, 156, and 160.

The supplier hosted stores 24 are the stores opened and individually maintained by a specific supplier. The supplier uploads its catalog data to the supplier hosted store 24. Through the supplier hosted store 24, the supplier can specify supplier-specific categories, products or items that are not found within the catalog topology in the catalog asset store 152. In other words, if the catalog asset store 152 provided for a category entitled “memory” and within that category a product entitled “128 MB memory chips”, a supplier may create a supplier-specific product entitled “256 MB memory chips” within the “memory” category. In the model 150 shown in FIG. 4, supplier hosted store 24a specifies product 162, supplier hosted store 24b specifies subcategory 158 and product 164, and supplier hosted store 24c specifies no additional categories or products. A category or subcategory may contain one or more products and each product may contain one or more items. An item constitutes the actual saleable thing that the supplier is offering for purchase and it has an associated offer price. All suppliers can specify offer prices for items created by the marketplace administrator.

The supplier hub store 28 has a ‘child-to-parent’ relationship with the catalog asset store 152, and with each supplier hosted store 24a, 24b and 24c. This means that when a buyer browses the supplier hub store 28, the aggregated catalog 30 available to the buyer (before considering entitlement access issues) is assembled based upon data from the catalog asset store 152 and from each of the supplier hosted stores 24. Accordingly, a buyer in the supplier hub store 28 is able to view marketplace categories/products 154, 156, and 160 as well as supplier-specific categories/products 158, 162, 164.

The supplier hosted stores 24 have a ‘child-to-parent’ relationship with the catalog asset store 152, meaning that when a buyer browses the supplier hosted store 24, the aggregated catalog 30 visible to the buyer (before considering entitlement access issues) is assembled based upon data from the specific hosted supplier store 24 and from the catalog asset store 152, but not from other hosted supplier stores 24. Accordingly, a buyer in hosted supplier store 24a is able to view marketplace categories/products 154, 156, and 160, and supplier-specific product 162, but not subcategory 158 or product 164.

Notionally, the foregoing scheme uses a set of store path relationships 166 between the hosted supplier stores 24, the supplier hub store 28, and the catalog asset store 152 that define what portions of the aggregated catalog 30 are visible to a buyer depending upon the store the buyer is browsing within. Contract entitlement also determines what categories, products, and items are visible to a buyer, as is explained further below.

Referring again to FIG. 3, the member subsystem 204 implements the personalization functions 120 (FIG. 2) by managing requests for registration from buyers and suppliers. The member subsystem 204 associates members with organizations and can maintain an organizational hierarchy. It also defines the roles and entitlements of registered members.

The access control subsystem 212 cooperates with the member subsystem 204 to ensure the roles of particular users are respected in terms of what can be accessed or edited.

The orders subsystem 214 manages the ordering process, including maintaining a table of orders, sending purchase orders to suppliers or notifying them that a purchase order has been submitted by a buyer, notifying buyers when the suppliers are given the purchase orders, and handling any rejected purchase orders.

The reports subsystem 216 allows for various reports to be generated with regard to various aspects of the system 200. The nature of the reports available to a particular user depends upon that user's role and status within the system 200.

The approval flow subsystem 220 implements a single level approval process for order and registration approvals in the system 200. The administrator can specify which activities require approval and who the approver should be. An approver is notified if an activity requires their approval, which they can accept or reject. The requesting party is notified that their action requires approval and is notified once the action has been accepted or rejected.

The trading subsystem 206 provides the trading mechanisms to enable buyers and sellers to negotiate an agreed upon trade. For example, the trading subsystem 206 allows suppliers to institute an auction of one or more items in the hosted supplier store 24 (FIG. 1) and permits buyers to submit bids for the items on auction in the supplier hub 28 (FIG. 1).

The trading subsystem 206 also provides an RFQ process, which, for instance, allows buyers to issue RFQs to multiple suppliers. RFQs can be open to all suppliers in the marketplace or can be targeted to specific suppliers who are invited to respond.

The catalog subsystem 202 provides the buyer with catalog browsing and searching ability so as to allow the buyer to find categories and/or products of interest. In developing an RFQ, the buyer may add any items in the catalog to the RFQ. If the buyer cannot locate a desired product within the catalog, he or she can submit an RFQ for the desired product. The buyer may customize the RFQ to add personalized attributes to any catalog product or made-to-order product in order to ensure the desired product specifications are accounted for the quotations. From within the supplier hub 28 (FIG. 1), the buyer drafts the RFQ using a provided online transaction toolkit and chooses whether to make the RFQ public or target it to specific suppliers.

Up until the RFQ is closed, the invited suppliers may submit responses if they want to offer a price on the requested product. Once the RFQ is closed, the buyer can review, then accept or reject the RFQ responses submitted by the invited suppliers and the suppliers are notified of the evaluation results. The buyer can then create a further round RFQ to further narrow a set of suppliers down using even greater product specifications, or the buyer can create and order or contract with the accepted RFQ response.

The orders subsystem 214 provides an order management process for the suppliers to manage the order resulting from the RFQ process. The contracts subsystem 208 provides a contract management process for the suppliers to manage any buyer contracts resulting from the RFQ process. The approval flow subsystem 220 manages the process of obtaining any necessary approvals within the RFQ process, such as for responses or for resulting orders or contracts.

In the case of an RFQ directed to a made-to-order item, the suppliers may substitute with any item already in their catalog. If the supplier does not have an item within their catalog that the supplier believes meets the buyer's needs, then the supplier may generate a new stock keeping unit (SKU) and add the new item to the supplier's catalog. The new SKU is generated by the supplier using a Product Management Tool (PMT) in the catalog subsystem 202. The supplier should not use a product as a substitute in the response; any response to an RFQ for a made-to-order item should specify an item. Therefore, if the supplier creates a new product using the PMT, the supplier should also create a specific item entry within that product. If such items are not intended for sale to the general public and are only meant for the specific made-to-order item, they may be blocked from inclusion in the aggregated catalog 30 as a supplier-specific item. The made-to-order items may also be removed from the supplier catalog once the supplier has finished with the RFQ process and any resulting orders or contracts relating to that particular item.

The contracts subsystem 208 ensures the contractual arrangements between specific buyers and suppliers are captured and implemented. When a price is negotiated between a buyer and a supplier, whether through an RFQ process, a negotiation process, or any other manner of reaching agreement, then the contracts subsystem 208 ensures that the agreed upon pricing arrangements are respected in subsequent transactions. For example, two parties may agree upon a 10 percent discount off of regular price for an item when purchased in quantities of 100 or more. When orders are subsequently placed for the item by the buyer, the contracts subsystem ensures that the appropriate pricing is applied during the transaction to reflect any agreed upon discount for volume purchases.

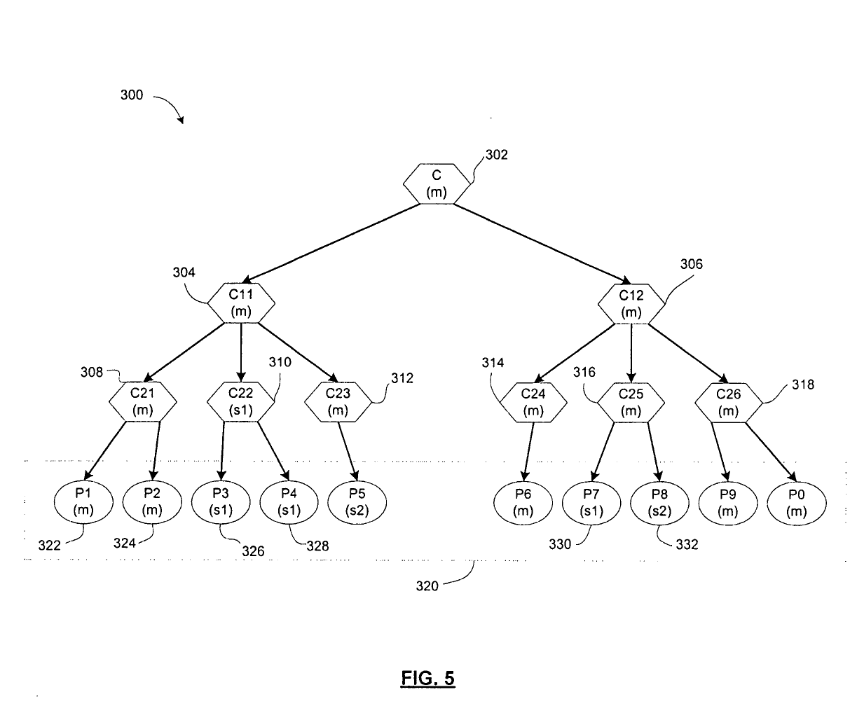

Reference is now made to FIG. 5, which shows a tree-and-branch diagram of an aggregated catalog 300 according to the present invention. The aggregated catalog 300 includes a variety of categories, subcategories, and products. The aggregated catalog 300 also includes a plurality of items that are arranged within appropriate categories, subcategories, or products.

In the example shown in FIG. 5, the aggregated catalog 300 includes a top level category 302 encompassing the whole of the aggregated catalog 300. Within the top level are a first and a second subcategory 304, 306. The first subcategory, in turn, includes three sub-subcategories 308, 310, 312. Similarly, the second subcategory includes three sub-subcategories 314, 316, 318.

At the lowest level of the aggregated catalog 300 are a plurality of products 320. For example, sub-subcategory 308 contains two products 322, 324.

The structure of the aggregated catalog 300, i.e. the structure of its categories, subcategories, products, items, etc., may be defined by the system administrator 16 (FIG. 1).

The catalog structure can specify a taxonomy that is an extension of an industry standard classification scheme, or it could be a simple layout without any taxonomy. For example, the catalog structure may be a multi-level hierarchical tree with multiple categories and products, or it may be a simple two-level structure with one category for each supplier for simplicity. The degree of complexity is configurable by the marketplace administrator 16.

Suppliers may then upload their own product/item information, grouped according to the catalog topology defined by the administrator 16. For example, for certain commodity items that are fully specified by the administrator 16 a registered supplier may simply specify its particular offer price for that item. Suppliers may also add their own subcategories, products, or items to the aggregated catalog 300. For example, all the subcategories 304, 306, all but one of the sub-subcategories 308, 312, 314, 316, 318, and five of the products 320 are defined to be “marketplace” categories/products, meaning that they are administrator-defined portions of the catalog topology. One of the sub-subcategories 310 is defined by a first supplier who chose to create the sub-subcategory to contain a certain pair of products 326, 328 offered through the first supplier's hosted store front 24(FIG. 1). The ownership and control over access to this sub-subcategory 310 and to these two products 326, 328 belongs to the first supplier. Accordingly, the first supplier could impose contact based restrictions on accessing these items, i.e. only buyers with existing contracts with the first supplier may be entitled to access these items.

Those products 320 designated with an “M” symbol are “open marketplace” or “shared” products that may be accessed through the supplier hub 28 and within individual hosted supplier stores 24. The first supplier products 326, 328, and 330 are only available through the supplier hub 28 and the first supplier's hosted store 24. A second supplier may also upload a product 332 designated to be available only through the second supplier's hosted store 24 and the supplier hub 28.

In accordance with the store path relationships 166 (FIG. 4) discussed above with reference to FIG. 4, a buyer browsing the aggregated catalog 300 in the supplier hub 28 may view all “marketplace” categories and products and all supplier-specific categories and products, i.e. all categories and products, subject to any entitlement restrictions in the contract under which the buyer has chosen to browse. A buyer browsing within the first supplier's store will be able to view all “marketplace” categories and products and all designated first supplier categories and products, again, subject to any entitlement restrictions in the relevant contract.

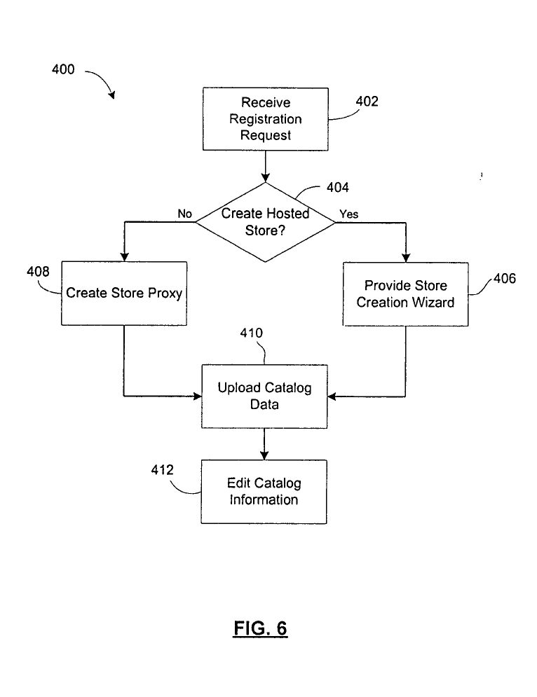

Reference is now made to FIG. 6, which shows, in flowchart form, a method 400 for hosting suppliers and providing a marketplace.

The method begins 400 in step 402 when the system 200 (FIG. 3) receives a request from a supplier to register. The supplier submits the requisite information to register as a seller organization within the marketplace. The supplier hub administrator 16 (FIG. 1) may optionally approve the registration request from the supplier. Once the approval is granted, the supplier is advised by way of e-mail or other notification.

Once the supplier has been registered, the system 200 provides the supplier with the option of creating a hosted store 24 (FIG. 1) in step 404. The system 200 launches a store creation wizard in step 406 to assist the supplier in customizing their store to their particular production, marketing, and/or branding needs, including supported languages and currencies, acceptable payment methods and terms, and a customized look & feel for the store. The wizard may provide the supplier with a number of default options so as to render the store creation process as simple as possible, but yet provide the capability to customize the store creation at a very detailed level if the supplier has the desire and technological capability.

If the supplier does not choose to create a store, the system 200 may, in step 408, create a store proxy for communicating transactional information, like purchase orders, etc., between the supplier's own remote commerce system and the present system 200.

Once the store front has been created, the supplier manages its hosted store catalog data. The catalog data may be edited in a spreadsheet format and exported in CSV format. The system 200 provides the hosted supplier with a catalog import utility for uploading CSV files and publishing their catalog data to the supplier's hosted supplier store. Once the data is published to the hosted supplier store, the supplier catalog data is automatically aggregated to the supplier hub 28 with other supplier catalogs and with the catalog data in the catalog asset store 152 (FIG. 4).

After the catalog data is uploaded to the system 200, then in step 412 the supplier can edit the information to specify pricing and access restrictions using the PMT as part of the hosted store management tools provided by the catalog subsystem 202 (FIG. 3). For example, the supplier may decide to specify certain contract prices for particular items. Some of the supplier's items will fall within marketplace products available through the supplier hub 28 and all hosted supplier stores, some supplier-specific items may be available through the supplier hub 28 and the supplier's hosted store (if one has been established), and some supplier-specific items may be designated for the supplier's store only (if one has been established). Still other items may be specific to one or more buyers, thereby only being accessible to buyer having the requisite entitlement, as more fully described below.

Following the foregoing setup steps, the system 200 makes the aggregated catalog, including the supplier's uploaded marketplace catalog items, available to registered buyer|'s browsing the marketplace. The system 200 also makes the supplier's store available, subject to any access restrictions specified by the supplier.

The supplier may then receive RFQs, establish auctions, receive orders, either through the supplier's store or through the general marketplace, and otherwise participate in the use of any of the trading mechanisms implemented within the system 200.

Buyers who access the online marketplace 18 (FIG. 1) may browse for categories/products/items in the supplier hub 28 or in individual hosted supplier stores 24 (FIG. 1). Buyers register with the administrator 16 (FIG. 1) before being granted access to the online marketplace 18. Accordingly, the system 200 (FIG. 3) is aware of the buyer's identity and can identify contracts between the buyer and any of the suppliers. These contracts can affect the entitlements of the particular buyer. The entitlements may include what items the buyer is permitted to view and what pricing is associated with certain items.

When browsing the online marketplace 18, the buyer may choose to operate under a specific contract or contracts if they are interested in particular suppliers or items; however, they need not browse in the context of a particular contract. The normal pricing applied to items (as specified by the individual suppliers for the items they offer) may be considered a “default contract” or a “supplier hub contract”. The “supplier hub contract” is the default contract under which a buyer browses the online marketplace 18.

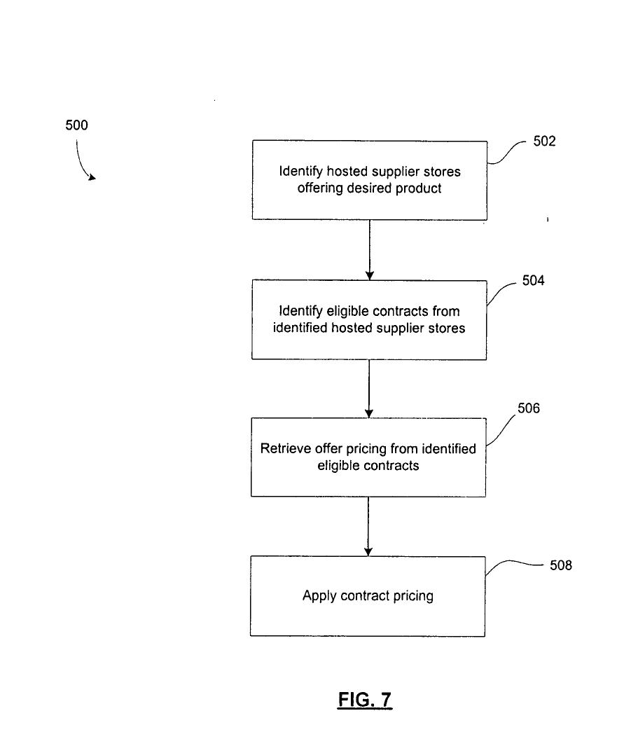

Reference is now made to FIG. 7, which shows a flowchart of a method 500 of determining pricing entitlement, according to the present invention.

The method 500 optimizes the pricing performed by a pricing engine. Rather than beginning with a step of identifying all contracts in the system 200 that the buyer is eligible to shop under, the method 500 begins in step 502 by identifying all supplier hosted stores that offer the product of interest. Accordingly, the total suppliers are filtered down to those hosted suppliers that have an offer price with respect to an item within the product category the buyer is interested in.

In step 504, the system 200 identifies all the contracts that the buyer is eligible to shop under that relate to the product of interest and that are within the filtered list of hosted supplier stores. Once this step is performed, the system 200 has identified all hosted suppliers that offer the product of interest, and any eligible contracts with those hosted suppliers that affect the entitlement of this particular buyer.

In step 506, the system 200 retrieves offer pricing from the identified eligible contracts, and in step 508 the system applies that offer pricing to the item of interest.

Using the method 500, the system 200 quickly obtains and applies entitlement-based pricing to item(s) that a buyer is considering. Accordingly, the buyer is able to quickly compare the relative offerings of a plurality of suppliers, including offerings that are specific to the entitlement of the buyer based upon contracts between the buyer and individual suppliers. The foregoing method 500 may be implemented within the system 200 through an optimization module.

Once a buyer has identified a product of interest and the system 200 has performed the method 500 so as to identify eligible contracts and apply the contract pricing to items on offer, then it would be advantageous to permit the buyer to switch stores without requiring the system 200 to re-perform the method 500 to once again identify the eligible contracts. In a supply chain, a buyer is normally eligible for a large number of contracts, so storing them all in a cookie or the session is problematic. Accordingly, the system 200 stores only the identified eligible contracts resulting from step 504 of the method 500 in a cookie or the session. In one embodiment, this entails storing a unique contract identification number for each identified eligible contract.

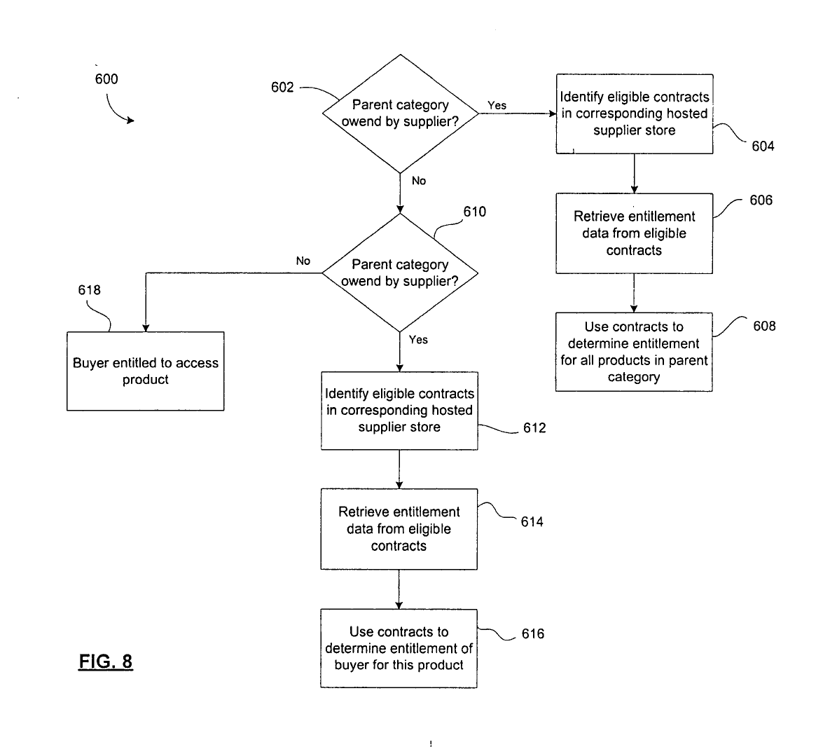

Reference is now made to FIG. 8, which shows a method 600 of determining access entitlement, according to the present invention. Using the method 600, the system 200 assesses whether a buyer is entitled to access/view particular items that suppliers have allocated under a certain product within a certain category.

The method 600 begins in step 602, wherein the system 200 (FIG. 3) assesses whether the category, or sub-category as the case may be, is ‘owned’ by the supplier hub 28, i. e. if it is a marketplace category, or if it is owned by a hosted supplier. If it is owned by a hosted supplier, then the method 600 knows that the access entitlement is subject to contracts within the corresponding hosted supplier store, so it proceeds to step 604, where it identifies any contracts in the corresponding hosted supplier store that the buyer is eligible for. From those contracts, the system 200 retrieves all entitlement information for the products that fall under the category or sub-category in step 606. It then applies that entitlement data to the products that fall under the category or sub-category in step 608 to determine the entitlement of this particular buyer to access this product.

If the category is owned by the supplier hub 28, then from step 602 the method 600 goes to step 610, wherein it assesses whether the product is owned by a hosted supplier.

If it is, then the method 600 knows that the access entitlement for that product is subject to contracts in the hosted supplier store, so it proceeds to step 612, where it identifies any contracts in the corresponding hosted supplier store that the buyer is eligible for. From those contracts the system 200 retrieves all entitlement information for the product in step 614. It then applies that entitlement data to the product in step 616 to determine the entitlement of this particular buyer to access this product.

If the product is a supplier hub 28 owned product, then from step 610 the method 600 proceeds to step 618. At step 618, it is apparent that the buyer is entitled to access the product offerings, since it is a ‘shared’ or ‘marketplace’ product.

Those of ordinary skill in the art will recognize that although the present invention is described above in conjunction with particular computer architecture, a system according to the present invention may be implemented upon a single computer or many computers. If more than one computer, the computers may be interconnected by way of a network or multiple networks, including the Internet, LANs, WANs, or any other network, and they may be clustered or unclustered.

The present invention may be embodied in other specific forms without departing from the spirit or essential characteristics thereof Certain adaptations and modifications of the invention will be obvious to those skilled in the art. Therefore, the above discussed embodiments are considered to be illustrative and not restrictive, the scope of the invention being indicated by the appended claims rather than the foregoing description, and all changes which come within the meaning and range of equivalency of the claims are therefore intended to be embraced therein.

What is claimed is:

1. A method of creating a marketplace with hosted supplier stores comprising the steps of:
providing tools for creating and managing a hosted supplier store to each of a plurality of suppliers through a commerce site, said tools including a catalog facility for uploading and managing a supplier catalog for said hosted supplier store;
receiving a plurality of supplier catalogs from said plurality of suppliers;
aggregating said plurality of supplier catalogs into an aggregated catalog; and
providing a buyer with access to said aggregated catalog on said commerce site.

2. The method of claim 1, further including:
providing a supplier hub catalog topology; and
wherein said step of aggregating includes aggregating said supplier catalogs according to said supplier hub catalog topology.

3. The method of claim 1, wherein:
said supplier catalogs include shared marketplace products and supplier-specific products;
said buyer accesses said aggregated catalog through one of said hosted supplier stores owned by one of said suppliers; and
said step of aggregating includes aggregating said shared marketplace products from all of said suppliers with said supplier-specific products from said one of said suppliers.

4. The method of claim 1, further including:
receiving contract data from one of said suppliers, said contract data including entitlement information for said buyer in relation to a product; and
wherein the step of providing said buyer with access includes filtering said aggregated catalog based upon said entitlement information.

5. The method of claim 4, further including:
receiving a buyer request for said product; and
wherein said step of filtering includes identifying hosted supplier stores offering said product, identifying eligible contracts within said identified hosted supplier stores, retrieving entitlement information from said eligible contracts, and applying said retrieved entitlement information, wherein said entitlement information includes pricing.

6. The method of claim 1, further including the steps of:
providing said buyer with trading mechanisms for generating orders for items within said aggregated catalog;
developing requests for quotations for made-to-order items; and
negotiating contracts between said suppliers and said buyers.

7. A computer program having a computer-readable medium tangibly embodying computer executable instructions for creating a marketplace with hosted supplier stores, the computer executable instructions comprising:
computer executable tools for creating and managing a hosted supplier store through a commerce site, said tools including a catalog facility for uploading and managing a supplier catalog for said hosted supplier store;
computer executable instructions for receiving a plurality of supplier catalogs from said plurality of suppliers;
computer executable instructions for aggregating said plurality of supplier catalogs into an aggregated catalog; and
computer executable instructions for providing a buyer with access to said aggregated catalog on said commerce site.

8. The computer program of claim 7, further including:
computer executable instructions defining a supplier hub catalog topology; and
wherein said computer executable instructions for aggregating include computer executable instructions for aggregating said supplier catalogs according to said supplier hub catalog topology.

9. The computer program of claim 7, wherein:
said supplier catalogs include shared marketplace products and supplier-specific products;
said buyer accesses said aggregated catalog through one of said hosted supplier stores owned by one of said suppliers; and
said computer executable instructions for aggregating include computer executable instructions for aggregating said shared marketplace products from all of said suppliers with said supplier-specific products from said one of said suppliers.

10. The computer program of claim 7, further including:
computer executable instructions for receiving contract data from one of said suppliers, said contract data including entitlement information for said buyer in relation to a product; and
wherein said computer executable instructions for providing said buyer access to said aggregated catalog includes computer executable instructions for filtering said aggregated catalog based upon said entitlement information.

11. The computer program of claim 10, further including:
computer executable instructions for receiving a buyer request for said product; and
wherein said computer executable instructions for filtering include computer executable instructions for identifying hosted supplier stores offering said product, identifying eligible contracts within said identified hosted supplier stores, retrieving entitlement infonnation from said eligible contracts, and applying said retrieved entitlement information, wherein said entitlement information includes pricing.

12. The computer program of claim 7, further including the steps of:
computer executable instructions for providing said buyer with trading mechanisms for generating orders for items within said aggregated catalog;
developing requests for quotations for made-to-order items; and
negotiating contracts between said suppliers and said buyers.

13. A system for online commerce between multiple buyers and multiple suppliers, the system comprising:
a member subsystem for registering buyers and suppliers, whereby registered buyers are permitted to access said system for online commerce, and registered suppliers are permitted to access said system to create and manage a hosted supplier store;
a database having stored thereon a plurality of supplier catalogs uploaded by said registered suppliers for a plurality of said hosted supplier stores;
a catalog subsystem for aggregating said plurality of supplier catalogs into an aggregated catalog; and
an application server for providing said registered buyers with access to said aggregated catalog on said commerce site.

14. The system of claim 13, wherein said database further includes a defined supplier hub catalog topology, and wherein said catalog subsystem aggregates said supplier catalogs according to said supplier hub catalog topology.

15. The system of claim 13, wherein:
said supplier catalogs include shared marketplace products and supplier-specific products;
said registered buyer accesses said aggregated catalog through one of said hosted supplier stores owned by one of said registered suppliers; and
said catalog subsystem aggregates said shared marketplace products from all of said registered suppliers with said supplier-specific products from said one of said registered suppliers.

16. The system of claim 13, further comprising:
a contracts subsystem including contract data received from one of said registered suppliers, said contract data including entitlement information for said registered buyer in relation to a product; and
wherein said contract subsystem filters said aggregated catalog based upon said entitlement information before said application server provides said registered buyer with access to said filtered aggregated catalog.

17. The system of claim 16, wherein said entitlement information includes item pricing information.

18. The system of claim 13, further comprising a trading subsystem providing a transaction mechanism adapted for said registered buyers to generate orders for items within said aggregated catalog, develop requests for quotations for made-to-order items, and to negotiate contracts with said suppliers.

19. An online marketplace for commerce between multiple buyers and multiple suppliers, said online marketplace comprising:
a plurality of hosted supplier stores each managed by a respective registered supplier, said hosted supplier stores each including a supplier catalog containing a hierarchy of categories, products, and saleable items uploaded by said respective registered supplier;
an aggregated catalog containing a hierarchy of categories, products, and items that includes an aggregation of said supplier catalogs;
trading mechanisms, including item ordering and requests for quotations for items; and
a supplier hub through which a registered buyer browses said aggregated catalog and utilizes said trading mechanisms.

20. The online marketplace of claim 19, further including:
a plurality of contracts between registered buyers and registered suppliers, each of said contracts including entitlement information for one of said registered buyer in relation to a product of one of said registered suppliers; and
an entitlement-based filter for filtering said aggregated catalog based upon said entitlement information for a selected registered buyer, thereby enforcing one of said contracts.

21. A computer-readable data signal for propagation in a medium, the signal comprising computer-readable code for providing a marketplace with hosted supplier stores, the computer-readable code including:
means for creating and managing a hosted supplier store through a commerce site, said means for creating and managing including a catalog facility for uploading and managing a supplier catalog for said hosted supplier store;
means for uploading a supplier catalog to said hosted supplier store; and
means for receiving an aggregated catalog, whereby said aggregated catalog is an aggregation of said supplier catalog with other supplier catalogs associated with other hosted supplier stores, and a buyer is provided access to said aggregated catalog on said commerce site.

22. The computer-readable data signal of claim 21, further including:
means for specifying a supplier hub catalog topology, and
wherein said aggregated catalog is an aggregation of said supplier catalog and said other supplier catalogs according to said supplier hub catalog topology.

23. The computer-readable data signal of claim 21, wherein:
said supplier catalogs include shared marketplace products and supplier-specific products;
said buyer accesses said aggregated catalog through one of said hosted supplier stores owned by one of said suppliers; and
said aggregated catalog includes said shared marketplace products from all of said suppliers with said supplier-specific products from said one of said suppliers.

24. The computer-readable data signal of claim 21, further including:
means for receiving contract data from one of said suppliers, said contract data including entitlement information for said buyer in relation to a product; and
wherein said aggregated catalog provided for said buyer is filtered based upon said entitlement information.

25. The computer-readable data signal of claim 21, further including:
means for generating orders for items within said aggregated catalog;
developing requests for quotations for made-to-order items, and
negotiating contracts between said suppliers and said buyers.
